(19) United States
(12) Patent Application Publication
(10) Pub. No.: US 2026/0238037 A1
(43) Pub. Date: Aug. 13, 2026

(54) METHOD AND SYSTEM FOR SAVING ENERGY

(71) Applicant: ELECTRONICS AND TELECOMMUNICATIONS RESEARCH INSTITUTE, Daejeon (KR)

(72) Inventors: Chang-Sic CHOI, Daejeon (KR); Tai-yeon KU, Daejeon (KR); Wan Ki PARK, Daejeon (KR)

(21) Appl. No.: 19/442,942

(22) Filed: Jan. 7, 2026

(30) Foreign Application Priority Data
Feb. 7, 2025 (KR) 10-2025-0016022

(51) Int. Cl. H02J 13/14; H02J 13/182; H02J 105/12; H02J 105/53

(52) U.S. Cl. CPC H02J 13/14; H02J 13/182; H02J 2105/12; H02J 2105/53

(57) ABSTRACT

A system for saving energy is provided. The system includes a central control device configured to manage an energy operation of an energy-using facility and a local control device controlled by the central control device and configured to control a plurality of devices installed in the energy-using facility, wherein the central control device may be configured to, in response to an energy-saving request for saving energy for the energy-using facility, search for a first energy profile that defines a plurality of operation modes of the local control device, select any one of the plurality of operation modes based on a target value for saving energy of the energy-using facility included in the energy-saving request, and generate and transmit a command for setting the local control device to the selected operation mode, and wherein the local control device may be configured to control the plurality of devices based on the command.

### CROSS-REFERENCE TO RELATED APPLICATION

This application claims the benefit of Korean Patent Application No. 10-2025-0016022, filed on February 7, 2025, in the Korean Intellectual Property Office, the entire disclosure of which is incorporated herein by reference for all purposes.

### BACKGROUND

### Field of the Invention

One or more embodiments relate to a method and system for saving energy.

### Description of the Related Art

There is an increasing need for energy savings in various environments where energy is consumed, such as homes, buildings, and factories. A general energy consumption system for an energy-consuming environment operates according to operating procedures for achieving residential or functional purposes, and only operating procedures for specific emergency situations are established in advance for response.

Technologies of saving energy are applied in a limited manner according to static scenarios based on time and environment. For example, control procedures for saving energy are performed in special or specific situations, such as an elevator and emergency lighting operation scenario in a power-outage situation, lighting control based on seasons and sunrise/sunset, and stepped lighting control for locations with minimal inconvenience.

The above description has been possessed or acquired by the inventor(s) in the course of conceiving the present disclosure and is not necessarily an art publicly known before the present application is filed.

### SUMMARY

Embodiments provide technology of saving energy of an energy-using facility.

According to an embodiment, operations of a plurality of devices installed in an energy-using facility may be controlled through control commands of a central control device and a local control device.

Embodiments provide effective energy savings by controlling an energy consumption amount of a plurality of devices installed in an energy-using facility.

However, the technical aspects are not limited to the aforementioned aspects, and other technical aspects may be present.

According to an aspect, there is provided a system including a central control device configured to manage an energy operation of an energy-using facility and a local control device controlled by the central control device and configured to control a plurality of devices installed in the energy-using facility, wherein the central control device may be configured to, in response to an energy-saving request for saving energy for the energy-using facility, search for a first energy profile that defines a plurality of operation modes of the local control device, select any one of the plurality of operation modes based on a target value for saving energy of the energy-using facility included in the energy-saving request, and generate and transmit a command for setting the local control device to the selected operation mode, and wherein the local control device may be configured to control the plurality of devices based on the command.

The first energy profile may define an operation mode of the local control device for each target value for saving energy of the energy-using facility.

The local control device may be configured to, in response to the command, search for a second energy profile that defines a plurality of control commands for the plurality of devices, select any one control command for each of the plurality of devices from the plurality of control commands based on an operation mode included in the command, and control the plurality of devices by transmitting the selected control command for each of the plurality of devices to each of the plurality of devices.

The second energy profile may define an energy saving amount of an area in which the local control device is installed according to the operation mode of the local control device.

The second energy profile may define a plurality of control commands for the plurality of devices according to an energy saving amount of an area in which the local control device is installed according to the operation mode of the local control device.

The plurality of devices may be configured to, in response to the control command transmitted from the local control device, search for a third energy profile that defines an energy consumption amount of the plurality of devices, determine the energy consumption amount corresponding to the control command, and be operated based on the determined energy consumption amount.

According to another aspect, there is provided a method of saving energy of an energy-using facility, the method including, by a central control device configured to manage an energy operation of the energy-using facility, in response to an energy-saving request for saving energy for the energy-using facility, searching for a first energy profile that defines a plurality of operation modes of a local control device, selecting any one of the plurality of operation modes based on a target value for saving energy of the energy-using facility included in the energy-saving request, generating and transmitting a command for setting the local control device to the selected operation mode, and by the local control device controlled by the central control device and configured to control a plurality of devices installed in the energy-using facility, controlling the plurality of devices based on the command.

The first energy profile may define an operation mode of the local control device for each target value for saving energy of the energy-using facility.

The method may further include, by the local control device, in response to the command, searching for a second energy profile that defines a plurality of control commands for the plurality of devices, selecting any one control command for each of the plurality of devices from the plurality of control commands based on an operation mode included in the command, and controlling the plurality of devices by transmitting the selected control command for each of the plurality of devices to each of the plurality of devices.

The second energy profile may define an energy saving amount of an area in which the local control device is installed according to the operation mode of the local control device.

The second energy profile may define a plurality of control commands for the plurality of devices according to an energy saving amount of an area in which the local control device is installed according to the operation mode of the local control device.

The method may further include, by the plurality of devices, in response to the control command transmitted from the local control device, searching for a third energy profile that defines an energy consumption amount of the plurality of devices, determining the energy consumption amount corresponding to the control command, and being operated based on the determined energy consumption amount.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a system for saving energy, according to an embodiment;

FIG. 2 is a diagram illustrating a first energy profile according to an embodiment;

FIG. 3 is a diagram illustrating a second energy profile according to an embodiment;

FIG. 4 is a diagram illustrating a third energy profile according to an embodiment;

FIG. 5 is a flowchart illustrating an operation of a local control device, according to an embodiment;

FIG. 6 is a diagram illustrating a method of saving energy using an energy profile, according to an embodiment;

FIG. 7 is a diagram illustrating a method of saving energy, according to an embodiment;

FIG. 8 is a schematic block diagram of an electronic device according to an embodiment; and

FIG. 9 is a schematic block diagram of an electronic device according to another embodiment.

### DETAILED DESCRIPTION

The following detailed structural or functional description is provided as an example only and various alterations and modifications may be made to the embodiments. Accordingly, the embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly the second component may also be referred to as the first component.

It should be noted that if one component is described as being "connected", "coupled", or "joined" to another component, a third component may be "connected", "coupled", and "joined" between the first and second components, although the first component may be directly connected, coupled, or joined to the second component.

The singular forms "a", "an", and "the" are intended to include the plural forms as well, unless the context clearly indicates otherwise. As used herein, "A or B", "at least one of A and B", "at least one of A or B", "A, B or C", "at least one of A, B and C", and "at least one of A, B, or C," each of which may include any one of the items listed together in the corresponding one of the phrases, or all possible combinations thereof. It will be further understood that the terms "comprises/comprising" and/or "includes/including" when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which the present disclosure pertains. Terms, such as those defined in commonly used dictionaries, should be construed to have meanings matching with contextual meanings in the relevant art, and are not to be construed to have an ideal or excessively formal meaning unless otherwise defined herein.

Hereinafter, the embodiments are described in detail with reference to the accompanying drawings. When describing the embodiments with reference to the accompanying drawings, like reference numerals refer to like components, and any repeated description related thereto will be omitted.

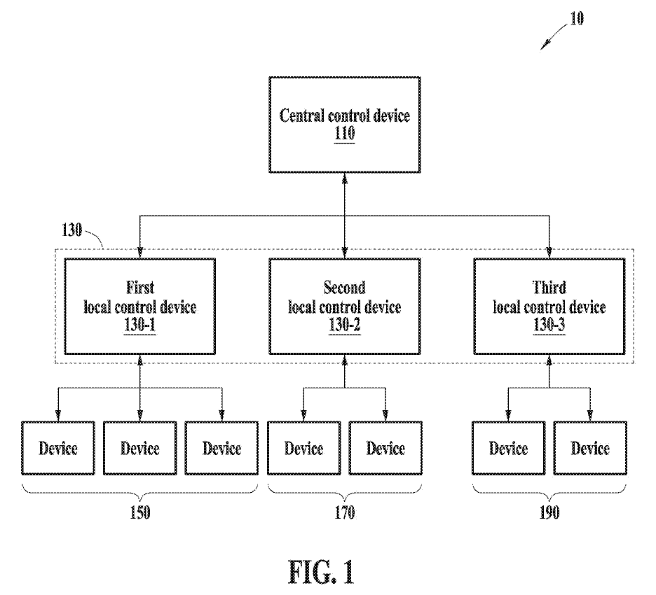

FIG. 1 is a diagram illustrating a system for saving energy, according to an embodiment.

Referring to FIG. 1, according to an embodiment, a system 10 for saving energy may include a central control device 110, local control devices 130, and a plurality of devices 150, 170, and 190. The local control devices 130 may include a first local control device 130-1, a second local control device 130-2, and a third local control device 130-3.

The central control device 110 may manage an operation of devices (e.g., the local control devices 130 and/or the plurality of devices 150, 170, and 190) installed in an energy-using facility. For example, the central control device 110 may select an operation mode of the local control devices 130 (e.g., the first local control device 130-1, the second local control device 130-2, and the third local control device 130-3) to manage the operation of the local control devices 130 (e.g., the first local control device 130-1, the second local control device 130-2, and the third local control device 130-3). The central control device 110 may generate a control command to set the operation mode of the local control devices 130 (e.g., the first local control device 130-1, the second local control device 130-2, and the third local control device 130-3) to the selected operation mode. The central control device 110 may transmit the generated control command to the local control devices 130 (e.g., the first local control device 130-1, the second local control device 130-2, and the third local control device 130-3).

The central control device 110 may be a device that provides a system manager with an interface for managing the operation of the system 10. For example, the central control device 110 may be a device that provides an interface for managing an energy operation of the energy-using facility.

The central control device 110 may obtain a request from the system manager to determine the energy operation of the energy-using facility. For example, the central control device 110 may obtain a request from the system manager to save energy of the energy-using facility. An energy-saving request may include a target value for saving energy of the energy-using facility. The target value for saving energy may be expressed as a percentage value. For example, when the target value for saving energy is 30 percent (%), this may refer to that target energy usage is 70 % of existing energy usage of the energy-using facility. The central control device 110 may control the local control devices 130 (e.g., the first local control device 130-1, the second local control device 130-2, and the third local control device 130-3) based on the request obtained from the system manager.

The local control devices 130 (e.g., the first local control device 130-1, the second local control device 130-2, and the third local control device 130-3) may control the plurality of devices 150, 170, and 190 installed in the energy-using facility. For example, the local control devices 130 (e.g., the first local control device 130-b, the second local control device 130-2, and the third local control device 130-3) may generate the control command to control the plurality of devices 150, 170, and 190. The local control devices 130 (e.g., the first local control device 130-1, the second local control device 130-2, and the third local control device 130-3) may transmit the generated control command to each of the plurality of devices 150, 170, and 190.

The local control devices 130 (e.g., the first local control device 130-1, the second local control device 130-2, and the third local control device 130-3) may be devices that control a plurality of devices included in an area in which the local control devices 130 (e.g., the first local control device 130-1, the second local control device 130-2, and the third local control device 130-3) are installed (or set to control the plurality of devices). For example, when the first local control device 130-1 is installed on the 7th floor of the energy-using facility (or set to control devices installed on the 7th floor), the first local control device 130-1 may be a device that controls a plurality of devices installed on the 7th floor. Alternatively, the first local control device 130-1 may be a device that controls a plurality of devices having a common function. For example, when the plurality of devices 150 is lighting devices of the energy-using facility, the first local control device 130-1 may integrate and control the plurality of devices 150 having a common function. When the plurality of devices 170 is heating and cooling devices of the energy-using facility, the second local control device 130-2 may control the plurality of devices 170.

The system manager may manage the operation of the system 10 through the central control device 110. The system manager may manage the energy operation of the energy-using facility through the central control device 110. For example, the system manager may input the target value for saving energy to the central control device 110 to save energy of the energy-using facility. When the system manager inputs the target value for saving energy to the central control device 110, the system 10 may be operated based on the target value set by the system manager, and thus the system manager may conveniently achieve an energy saving target.

The system 10 may be operated based on the target value for saving energy that the system manager inputs to the central control device 110. Depending on the target value for saving energy, operations of various devices (e.g., the local control devices 130 (e.g., the first local control device 130-1, the second local control device 130-2, and the third local control device 130-3) and the plurality of devices 150, 170, and 190) included in the system 10 may be linked and determined. For example, a multi-stage structure may be formed in which the central control device 110 controls the first local control device 130-1 according to the target value for saving energy and the first local control device 130-1 controls the plurality of devices 150 according to the control of the central control device 110. The system 10 may be operated based on energy according to the target value for saving energy. Accordingly, the system 10 may respond to various situations in which saving energy of the energy-using facility is required.

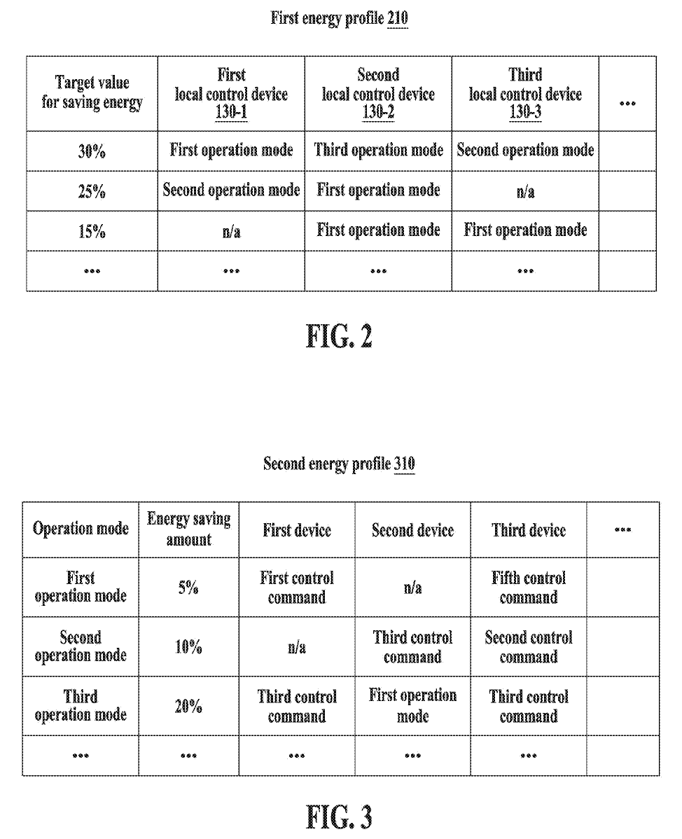

FIG. 2 is a diagram illustrating a first energy profile according to an embodiment.

Referring to FIG. 2, according to an embodiment, a first energy profile 210 may include a target value for saving energy of an energy-using facility and a plurality of operation modes corresponding to the target value.

The first energy profile 210 may be an energy profile used by the central control device 110. The first energy profile 210 may be for setting an operation mode of the local control devices 130 (e.g., the first local control device 130-1, the second local control device 130-2, and the third local control device 130-3). The first energy profile 210 may include the plurality of operation modes.

The first energy profile 210 may include the target value for saving energy of the energy-using facility. There may be a plurality of target values for saving energy of the energy-using facility. The first energy profile 210 may define the operation mode of the local control devices 130 (e.g., the first local control device 130-1, the second local control device 130-2, and the third local control device 130-3) for each target value for saving energy of the energy-using facility. For example, when the target value for saving energy of the energy-using facility is 30 %, referring to the first energy profile 210, the operation mode of the first local control device 130-1 defined at the target value of 30 % may be a first operation mode, the operation mode of the second local control device 130-2 may be a third operation mode, and the operation mode of the third local control device 130-3 may be a second operation mode.

The central control device 110 may obtain an energy-saving request from a system manager to save energy of the energy-using facility. The energy-saving request may include the target value for saving energy of the energy-using facility. The central control device 110 may search for the first energy profile 210 in response to the energy-saving request. The central control device 110 may select any one of the pluralities of operation modes based on the target value for saving energy of the energy-using facility included in the energy-saving request. For example, when the target value for saving energy included in the energy-saving request is 25 %, the central control device 110 may select the operation mode of the first local control device 130-1 as the second operation mode and the operation mode of the second local control device 130-2 as the first operation mode. The central control device 110 may generate a control command to set the local control devices 130 (e.g., the first local control device 130-1, the second local control device 130-2, and the third local control device 130-3) to the selected operation mode. The central control device 110 may transmit the generated control command to the local control devices 130 (e.g., the first local control device 130-1, the second local control device 130-2, and the third local control device 130-3).

FIG. 3 is a diagram illustrating a second energy profile according to an embodiment.

Referring to FIG. 3, according to an embodiment, a second energy profile 310 may include an operation mode, an energy saving amount, and a plurality of control commands.

The second energy profile 310 may be an energy profile used by the local control devices 130 (e.g., the first local control device 130-1, the second local control device 130-2, and the third local control device 130-3). The second energy profile 310 may be for defining the control commands to be transmitted to the plurality of devices 150, 170, and 190 installed in an energy-using facility.

The second energy profile 310 may include the energy saving amount for saving energy of an area in which the local control devices 130 (e.g., the first local control device 130-1, the second local control device 130-2, and the third local control device 130-3) are installed (or an area set to be controlled by the local control devices 130). There may be a plurality of energy saving amounts for saving energy of the area in which the local control devices 130 (e.g., the first local control device 130-1, the second local control device 130-2, and the third local control device 130-3) are installed (or set to control devices). The second energy profile 310 may define the control commands for the plurality of devices 150, 170, and 190 according to the energy saving amount of the area in which the local control devices 130 (e.g., the first local control device 130-1, the second local control device 130-2, and the third local control device 130-3) are installed (or set to control devices).

The local control devices 130 (e.g., the first local control device 130-1, the second local control device 130-2, and the third local control device 130-3) may set the operation mode of the local control devices 130 based on the control commands of the central control device 110. The local control devices 130 (e.g., the first local control device 130-1, the second local control device 130-2, and the third local control device 130-3) may search for the second energy profile 310 in response to the control commands from the central control device 110. The local control devices 130 (e.g., the first local control device 130-1, the second local control device 130-2, and the third local control device 130-3) may select the control commands to be transmitted to each of the plurality of devices 150, 170, and 190 based on the set operation mode. The local control devices 130 (e.g., the first local control device 130-1, the second local control device 130-2, and the third local control device 130-3) may generate the selected control commands. The local control devices 130 (e.g., the first local control device 130-1, the second local control device 130-2, and the third local control device 130-3) may transmit the generated control commands to the plurality of devices 150, 170, and 190.

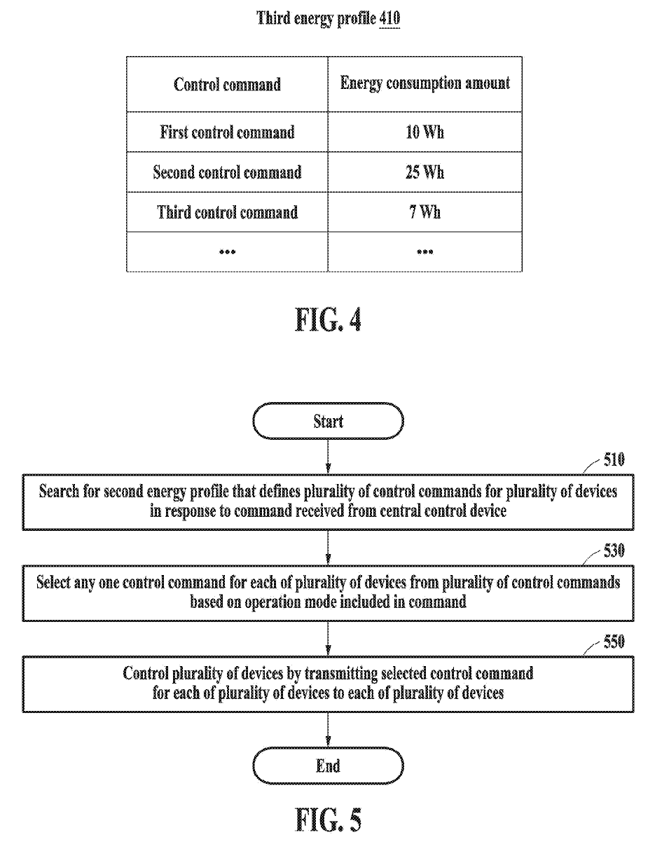

FIG. 4 is a diagram illustrating a third energy profile according to an embodiment.

Referring to FIG. 4, according to an embodiment, a third energy profile 410 may include a control command and an energy consumption amount.

The third energy profile 410 may be an energy profile used by the plurality of devices 150, 170, and 190 installed in an energy-using facility. The third energy profile 410 may be for determining the energy consumption amount of the plurality of devices 150, 170, and 190. In the third energy profile 410, the energy consumption amount may be defined in response to the control command received by each of the plurality of devices 150, 170, and 190.

The plurality of devices 150, 170, and 190 may search for the third energy profile 410 in response to the control command transmitted from the local control devices 130 (e.g., the first local control device 130-1, the second local control device 130-2, and the third local control device 130-3). The plurality of devices 150, 170, and 190 may determine the energy consumption amount based on the energy consumption amount corresponding to the received control command. The plurality of devices 150, 170, and 190 may be operated based on the determined energy consumption amount. For example, when one of the plurality of devices 150, 170, and 190 receives a first control command, the device may determine the energy consumption of the device to be 10 watt-hours (Wh). When the device determines the energy consumption of the device to be 10Wh, the device may be operated to consume 10Wh of energy.

FIG. 5 is a flowchart illustrating an operation of a local control device, according to an embodiment.

Referring to FIG. 5, according to an embodiment, operations 510 to 550 may be performed by the local control devices 130 of FIG. 1 (e.g., the first local control device 130-1, the second local control device 130-2, and the third local control device 130-3) described with reference to FIGS. 1 to 4.

In operation 510, the local control devices 130 (e.g., the first local control device 130-1, the second local control device 130-2, and the third local control device 130-3) may search for a second energy profile that defines a plurality of control commands for a plurality of devices (e.g., the plurality of devices 150, 170, and 190 of FIG. 1) in response to a command received from a central control device (e.g., the central control device 110 of FIG. 1).

In operation 530, the local control devices 130 (e.g., the first local control device 130-1, the second local control device 130-2, and the third local control device 130-3) may select any one control command for each of the plurality of devices 150, 170, and 190 from the plurality of control commands based on an operation mode included in the command received from the central control device 110.

In operation 550, the local control devices 130 (e.g., the first local control device 130-1, the second local control device 130-2, and the third local control device 130-3) may control the plurality of devices 150, 170, and 190 by transmitting the selected control command for each of the plurality of devices 150, 170, and 190 to each of the plurality of devices 150, 170, and 190.

Operations 510 to 550 may be performed sequentially, but embodiments are not limited thereto. For example, two or more operations may be performed in parallel. Operations 510 to 550 may be substantially the same as the method of saving energy of an energy-using facility, according to an embodiment, performed by the local control devices 130 (e.g., the first local control device 130-1, the second local control device 130-2, and the third local control device 130-3) described with reference to FIGS. 1 to 4.

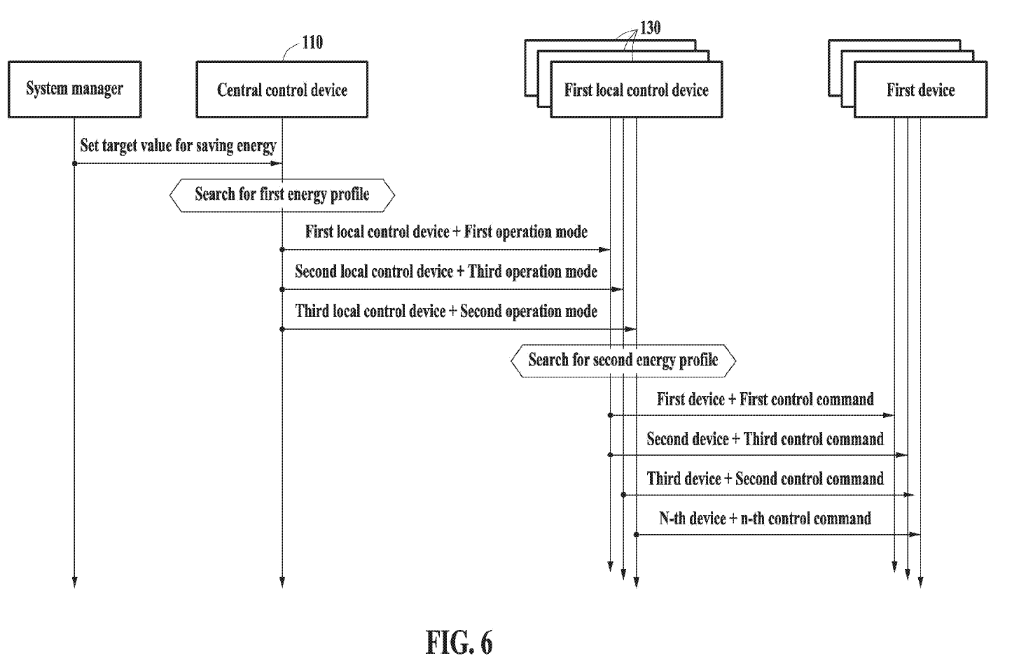

FIG. 6 is a diagram illustrating a method of saving energy using an energy profile, according to an embodiment.

Referring to FIG. 6, according to an embodiment, the method of saving energy using an energy profile may be performed by a system manager, a central control device, a plurality of local control devices, and a plurality of devices.

The system manager may set a target value for saving energy of an energy-using facility in the central control device 110.

The central control device 110 may search for the first energy profile 210 in response to a request from the system manager. The central control device 110 may determine an operation mode of the local control devices 130 (e.g., the first local control device 130-1, the second local control device 130-2, and the third local control device 130-3) based on the result of searching for the first energy profile 210. For example, the central control device 110 may generate a control command that determines the operation mode of the local control devices 130 (e.g., the first local control device 130-1, the second local control device 130-2, and the third local control device 130-3). The central control device 110 may transmit the generated control command to the local control devices 130 (e.g., the first local control device 130-1, the second local control device 130-2, and the third local control device 130-3).

The local control devices 130 (e.g., the first local control device 130-1, the second local control device 130-2, and the third local control device 130-3) may search for the second energy profile 310 in response to the control command from the central control device 110. The local control devices 130 (e.g., the first local control device 130-1, the second local control device 130-2, and the third local control device 130-3) may select the control command for each of the plurality of devices (e.g., the plurality of devices 150, 170, and 190 of FIG. 1) based on the result of searching for the second energy profile 310. The local control devices 130 (e.g., the first local control device 130-1, the second local control device 130-2, and the third local control device 130-3) may transmit the selected control command for each of the plurality of devices 150, 170, and 190 to each of the plurality of devices 150, 170, and 190.

The plurality of devices 150, 170, and 190 may search for the third energy profile 410 in response to the control command received from the local control devices 130 (e.g., the first local control device 130-1, the second local control device 130-2, and the third local control device 130-3). The plurality of devices 150, 170, and 190 may determine an energy consumption amount of each of the plurality of devices 150, 170, and 190 based on the result of searching for the third energy profile 410. The plurality of devices 150, 170, and 190 may be operated based on the determined energy consumption amount.

The energy consumption amount of the plurality of devices 150, 170, and 190 installed in the energy-using facility may be controlled based on the target value for saving energy set by the system manager. As the energy consumption amount of the plurality of devices 150, 170, and 190 is controlled, energy of the energy-using facility may be saved.

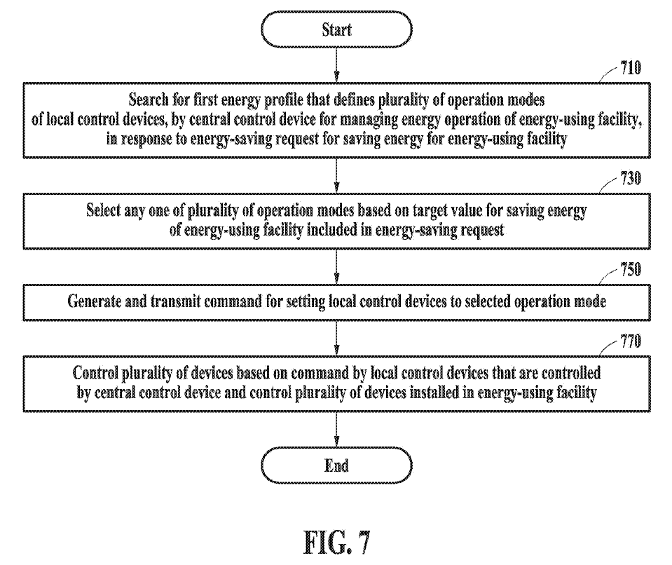

FIG. 7 is a diagram illustrating a method of saving energy, according to an embodiment.

Referring to FIG. 7, according to an embodiment, operations 710 to 770 may be performed by the central control device 110 and the local control devices 130 of FIG. 1 (e.g., the first local control device 130-1, the second local control device 130-2, and the third local control device 130-3) described with reference to FIGS. 1 to 6.

In operation 710, a central control device (e.g., the central control device 110 of FIG. 1) for managing an energy operation of an energy-using facility may search for a first energy profile that defines a plurality of operation modes of local control devices (e.g., the local control devices 130 of FIG. 1) in response to an energy-saving request for saving energy for the energy-using facility.

In operation 730, the central control device 110 may select any one of the plurality of operation modes based on a target value for saving energy of the energy-using facility included in the energy-saving request.

In operation 750, the central control device 110 may generate and transmit a command for setting the local control devices 130 (e.g., the first local control device 130-1, the second local control device 130-2, and the third local control device 130-3) to the selected operation mode.

In operation 770, the local control devices 130 (e.g., the first local control device 130-1, the second local control device 130-2, and the third local control device 130-3), which are controlled by the central control device 110 and control a plurality of devices installed in the energy-using facility, may control the plurality of devices based on the command from the central control device 110.

Operations 710 to 770 may be performed sequentially, but embodiments are not limited thereto. For example, two or more operations may be performed in parallel. Operations 710 to 770 may be substantially the same as the method of saving energy of an energy-using facility, according to an embodiment, performed by the central control device 110 and the local control devices 130 (e.g., the first local control device 130-1, the second local control device 130-2, and the third local control device 130-3) described with reference to FIGS. 1 to 6.

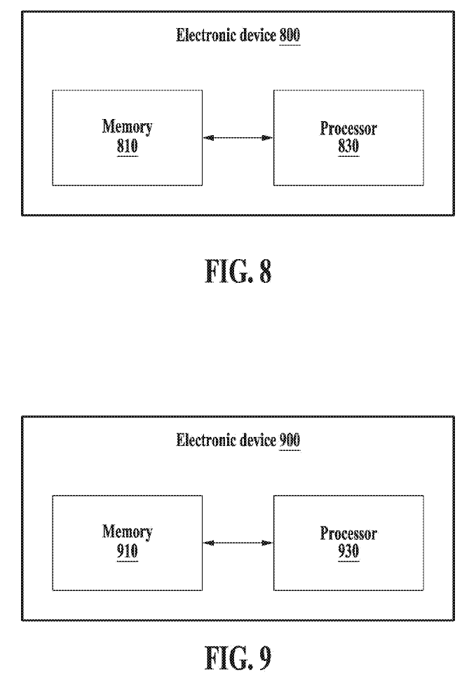

FIG. 8 is a schematic block diagram of an electronic device according to an embodiment.

Referring to FIG. 8, according to an embodiment, an electronic device 800 (e.g., the central control device 110 of FIG. 1) may include a memory 810 and a processor 830.

The memory 810 may store instructions (or programs) executable by the processor 830. For example, the instructions may include instructions to perform an operation of the processor 830 and/or an operation of each component of the processor 830.

The memory 810 may include one or more computer-readable storage media. The memory 810 may include non-volatile storage elements (e.g., a magnetic hard disc, an optical disc, a floppy disc, flash memory, electrically programmable memory (EPROM), and electrically erasable and programmable memory (EEPROM)).

The memory 810 may be a non-transitory medium. The term “non-transitory” may indicate that a storage medium is not embodied in a carrier wave or a propagated signal. However, the term "non-transitory" should not be interpreted to mean that the memory 810 is non-movable.

The processor 830 may process data stored in the memory 810. The processor 830 may execute computer-readable code (e.g., software) stored in the memory 810 and instructions triggered by the processor 830.

The processor 830 may be a hardware-implemented data processing device having a circuit that is physically structured to execute desired operations. The desired operations may include, for example, code or instructions included in a program.

The hardware-implemented data processing device may include, for example, a microprocessor, a central processing unit (CPU), a processor core, a multi-core processor, a multiprocessor, an application-specific integrated circuit (ASIC), and a field-programmable gate array (FPGA).

The processor 830 may cause the electronic device 800 to perform one or more operations by executing the code and/or instructions stored in the memory 810. The operations performed by the electronic device 800 may be substantially the same as the operations performed by the central control device 110 described with reference to FIGS. 1 to 8. Accordingly, a repeated description thereof is omitted.

FIG. 9 is a schematic block diagram of an electronic device according to another embodiment.

Referring to FIG. 9, according to another embodiment, an electronic device 900 (e.g., the local control devices 130 of FIG. 1) may include a memory 910 and a processor 930.

The memory 910 may store instructions (or programs) executable by the processor 930. For example, the instructions include instructions for performing an operation of the processor 930 and/or an operation of each component of the processor 930.

The memory 910 may include one or more computer-readable storage media. The memory 910 may include non-volatile storage elements (e.g., a magnetic hard disc, an optical disc, a floppy disc, flash memory, EPROM, and EEPROM).

The memory 910 may be a non-transitory medium. The term “non-transitory” may indicate that a storage medium is not embodied in a carrier wave or a propagated signal. However, the term "non-transitory" should not be interpreted to mean that the memory 910 is non-movable.

The processor 930 may process data stored in the memory 910. The processor 930 may execute computer-readable code (e.g., software) stored in the memory 910 and instructions triggered by the processor 930.

The processor 930 may be a hardware-implemented data processing device including a circuit having a physical structure to perform desired operations. The desired operations may include, for example, code or instructions included in a program.

The hardware-implemented data processing device may include, for example, a microprocessor, a CPU, a processor core, a multi-core processor, a multiprocessor, an ASIC, and an FPGA.

The processor 930 may cause the electronic device 900 to perform one or more operations by executing the code and/or instructions stored in the memory 910. The operations performed by the electronic device 900 may be substantially the same as the operations performed by the local control devices 130 (e.g., the first local control device 130-1, the second local control device 130-2, and the third local control device 130-3) described with reference to FIGS. 1 to 9. Accordingly, a repeated description thereof is omitted.

The components described in the embodiments may be implemented by hardware components including, for example, at least one digital signal processor (DSP), a processor, a controller, an ASIC, a programmable logic element, such as an FPGA, other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The embodiments described herein may be implemented using a hardware component, a software component and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor, or any other device capable of responding to and executing instructions in a defined manner. The processing device may run an operating system (OS) and one or more software applications that run on the OS. The processing device also may access, store, manipulate, process, and generate data in response to execution of the software. For purpose of simplicity, the description of a processing device is singular; however, one of ordinary skill in the art will appreciate that a processing device may include a plurality of processing elements and a plurality of types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or collectively instruct or configure the processing device to operate as desired. Software and data may be stored in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored in a non-transitory computer-readable recording medium.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) discs and digital video discs (DVDs); magneto-optical media such as optical discs; and hardware devices that are specifically configured to store and perform program instructions, such as read-only memory (ROM), random access memory (RAM), flash memory, and the like. Examples of program instructions include both machine code, such as one produced by a compiler, and files containing higher-level code that may be executed by the computer using an interpreter.

The above-described hardware devices may be configured to act as one or more software modules in order to perform the operations of the above-described embodiments, or vice versa.

As described above, although the embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents to the claims are also within the scope of the following claims.

What is claimed is:

1. A system comprising:
a central control device configured to manage an energy operation of an energy-using facility; and
a local control device controlled by the central control device and configured to control a plurality of devices installed in the energy-using facility,
wherein the central control device is configured to:
in response to an energy-saving request for saving energy for the energy-using facility, search for a first energy profile that defines a plurality of operation modes of the local control device;
select any one of the plurality of operation modes based on a target value for saving energy of the energy-using facility included in the energy-saving request; and
generate and transmit a command for setting the local control device to the selected operation mode, and
wherein the local control device is configured to control the plurality of devices based on the command.

2. The system of claim 1, wherein
the first energy profile defines an operation mode of the local control device for each target value for saving energy of the energy-using facility.

3. The system of claim 1, wherein
the local control device is configured to:
in response to the command, search for a second energy profile that defines a plurality of control commands for the plurality of devices;
select any one control command for each of the plurality of devices from the plurality of control commands based on an operation mode included in the command; and
control the plurality of devices by transmitting the selected control command for each of the plurality of devices to each of the plurality of devices.

4. The system of claim 3, wherein
the second energy profile defines an energy saving amount of an area in which the local control device is installed according to the operation mode of the local control device.

5. The system of claim 3, wherein
the second energy profile defines a plurality of control commands for the plurality of devices according to an energy saving amount of an area in which the local control device is installed according to the operation mode of the local control device.

6. The system of claim 3, wherein
the plurality of devices is configured to:
in response to the control command transmitted from the local control device, search for a third energy profile that defines an energy consumption amount of the plurality of devices;
determine an energy consumption amount corresponding to the control command; and
be operated based on the determined energy consumption amount.

7. A method of saving energy of an energy-using facility, the method comprising:
by a central control device configured to manage an energy operation of the energy-using facility,
in response to an energy-saving request for saving energy for the energy-using facility, searching for a first energy profile that defines a plurality of operation modes of a local control device;
selecting any one of the plurality of operation modes based on a target value for saving energy of the energy-using facility included in the energy-saving request;
generating and transmitting a command for setting the local control device to the selected operation mode; and
by the local control device controlled by the central control device and configured to control a plurality of devices installed in the energy-using facility,
controlling the plurality of devices based on the command.

8. The method of claim 7, wherein
the first energy profile defines an operation mode of the local control device for each target value for saving energy of the energy-using facility.

9. The method of claim 7, further comprising:
by the local control device,
in response to the command, searching for a second energy profile that defines a plurality of control commands for the plurality of devices;
selecting any one control command for each of the plurality of devices from the plurality of control commands based on an operation mode included in the command; and
controlling the plurality of devices by transmitting the selected control command for each of the plurality of devices to each of the plurality of devices.

10. The method of claim 9, wherein
the second energy profile defines an energy saving amount of an area in which the local control device is installed according to the operation mode of the local control device.

11. The method of claim 9, wherein
the second energy profile defines a plurality of control commands for the plurality of devices according to an energy saving amount of an area in which the local control device is installed according to the operation mode of the local control device.

12. The method of claim 9, further comprising:
by the plurality of devices,
in response to the control command transmitted from the local control device, searching for a third energy profile that defines an energy consumption amount of the plurality of devices;
determining an energy consumption amount corresponding to the control command; and
being operated based on the determined energy consumption amount.
